(19) United States
(12) Patent Application Publication
(10) Pub. No.: US 2006/0293430 A1
(43) Pub. Date: Dec. 28, 2006

(54) Exfoliated clay nanocomposites

(75) Inventors: Jin-Shan Wang, Pittsford, NY (US); Thomas N. Blanton, Rochester, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 11/156,789

(22) Filed: Jun. 20, 2005

(51) Int. Cl. C08K 9/04

(52) U.S. Cl. 524/445; 523/216; 252/378 R

(57) ABSTRACT

The present invention relates to a nanocomposite composition comprising a clay material splayed with an inorganic particle having a diameter equal to or less than 30 nanometers. Another embodiment of the invention includes a splayed material comprising a layered material splayed with a particle, wherein the particle comprises a diameter equal to or less than 30 nanometers. Another embodiment relates to a method for preparing an exfoliated nanocomposite composition comprising the steps of preparing an inorganic particle, mixing the particle with a layered material dispersed in a medium, and splaying the layered material to produce a nanocomposite, wherein the inorganic particle comprises a diameter equal to or less than 30 nanometers.

### FIELD OF THE INVENTION

The present invention relates to the use of inorganic nanoparticles having a diameter of 30 nanometers or less to splay layered materials.

### BACKGROUND OF THE INVENTION

Over the last decade or so, the utility of inorganic layered nanoparticles as additives to enhance polymer performance has been well established. Ever since the seminal work conducted at Toyota Central Research Laboratories, polymer-clay nanocomposites have generated a lot of interest across various industries. The unique physical properties of these nanocomposites have been explored by such varied industrial sectors as the automotive industry, the packaging industry, and plastics manufactures. These properties include improved mechanical properties, such as elastic modulus and tensile strength, thermal properties such as coefficient of linear thermal expansion and heat distortion temperature, barrier properties, such as oxygen and water vapor transmission rate, flammability resistance, ablation performance, solvent uptake, and the like. Some of the related prior art is illustrated in U.S. Pat. Nos. 4,739,007, 4,810,734, 4,894,411, 5,102,948, 5,164,440, 5,164,460, 5,248,720, 5,854,326, and 6,034,163.

In general, the physical property enhancements for these nanocomposites are achieved with less than 20 vol. % addition, and usually less than 10 vol. % addition of the inorganic phase, which is typically clay or organically modified clay. Although these enhancements appear to be a general phenomenon related to the nanoscale dispersion of the inorganic phase, the degree of property enhancement is not universal for all polymers. It has been postulated that the property enhancement is very much dependent on the morphology and degree of dispersion of the inorganic phase in the polymeric matrix. The clays in the polymer-clay nanocomposites are ideally thought to have three structures: (1) clay tactoids wherein the clay particles are in face-to-face aggregation with no organics inserted within the clay lattice, (2) intercalated clay wherein the clay lattice has been expanded to a thermodynamically defined equilibrium spacing due to the insertion of individual polymer chains, yet maintaining a long range order in the lattice, and (3) exfoliated clay wherein singular clay platelets are randomly suspended in the polymer, resulting from extensive penetration of the polymer into the clay lattice and its subsequent delamination. The greatest property enhancements of the polymer-clay nanocomposites are expected with the latter two structures mentioned herein above.

There has been considerable effort towards developing materials and methods for intercalation and/or exfoliation of clays and other layered inorganic materials. In addition to intercalation and/or exfoliation, the clay phase should also be rendered compatible with the polymer matrix in which they are distributed. The challenge in achieving these objectives arises from the fact that unmodified clay surfaces are hydrophilic, whereas vast number of thermoplastic polymers of technological importance are hydrophobic in nature. Although intercalation of clay with organic molecules may be obtained by various means, compatibilizing these intercalated clays in a polymer matrix for uniform distribution still poses considerable difficulty. In the industry, the clay suppliers normally provide just the intercalated clays and the end-users are challenged to select materials and processes for compatibilizing these clays in the thermoplastics of their choice. This selection process involves trial and error at a considerable development cost to the end-users. Since clay intercalation and compatibilization in the matrix polymer usually involve at least two distinct materials, processes, and sites, the overall cost of the product comprising the polymer-clay nanocomposite suffers.

A vast majority of intercalated clays are produced by interacting anionic clays with cationic surfactants including onium species such as ammonium (primary, secondary, tertiary, and quaternary), phosphonium, or sulfonium derivatives of aliphatic, aromatic or arylaliphatic amines, phosphines and sulfides. These onium ions may cause intercalation in the clay through ion exchange with the metal cations present in the clay lattice for charge balance. However, these surfactant molecules may degrade during subsequent melt-processing, placing severe limitation on the processing temperature and the choice of the matrix polymer. Moreover, the surfactant intercalation is usually carried out in the presence of water, which needs to be removed by a subsequent drying step.

Intercalation of clay with a polymer, as opposed to a low molecular weight surfactant, is also known in the art. There are two major intercalation approaches that are generally used—intercalation of a suitable monomer followed by polymerization (known as in-situ polymerization, see A. Okada et. al., Polym Prep., Vol. 28, 447, 1987) or monomer/polymer intercalation from solution. Polyvinyl alcohol (PVA), polyvinyl pyrrolidone (PVP) and polyethylene oxide (PEO) have been used to intercalate the clay platelets with marginal success. As described by Levy et. al, in “Interlayer adsorption of polyvinylpyrrolidone on montmorillonite”, Journal of Colloid and Interface Science, Vol 50 (3), 442, 1975, attempts were made to sorb PVP between the monoionic montmorillonite clay platelets by successive washes with absolute ethanol, and then attempting to sorb the PVP by contacting it with 1% PVP/ethanol/water solutions, with varying amounts of water. Only the Na-montmorillonite expanded beyond 20 Å basal spacing, after contacting with PVP/ethanol/water solution. The work by Greenland, “Adsorption of polyvinyl alcohol by montmorillonite”, Journal of Colloid Science, Vol. 18, 647-664 (1963) discloses that sorption of PVA on the montmorillonite was dependent on the concentration of PVA in the solution. It was found that sorption was effective only at polymer concentrations of the order of 1% by weight of the polymer. No further effort was made towards commercialization since it would be limited by the drying of the dilute intercalated layered materials. In a recent work by Richard Vaia et. al., “New Polymer Electrolyte Nanocomposites: Melt intercalation of polyethyleneoxide in mica type silicates”, Adv. Materials, 7(2), 154-156, 1995, PEO was intercalated into Na-montmorillonite and Li-montmorillonite by heating to 80C for 2-6 hours to achieve a d-spacing of 17.7 Å. The extent of intercalation observed was identical to that obtained from solution (V. Mehrotra, E. P. Giannelis, Solid State Commun., 77, 155, 1991). Other, recent work (U.S. Pat. No. 5,804,613) has dealt with sorption of monomeric organic compound having at least one carbonyl functionality selected from a group consisting of carboxylic acids and salts thereof, polycarboxylic acids and salts thereof, aldehydes, ketones and mixtures thereof. Similarly U.S. Pat. No. 5,880,197 discusses the use of an intercalating monomer that contains an amine or amide functionality or mixtures thereof. In both these patents, and other patents issued to the same group, the intercalation is performed at very dilute clay concentrations in a medium such as water, leading to a necessary and costly drying step, prior to melt-processing.

In order to further facilitate delamination and prevent reaggregation of the clay particles, these intercalated clays are required to be compatible with the matrix polymer in which they are to be incorporated. This may be achieved through the careful selection and incorporation of compatibilizing or coupling agents, which consist of a portion which bonds to the surface of the clay and another portion which bonds or interacts favorably with the matrix polymer. Compatibility between the matrix polymer and the clay particles ensures a favorable interaction, which promotes the dispersion of the intercalated clay in the matrix polymer. Effective compatibilization leads to a homogenous dispersion of the clay particles in the typically hydrophobic matrix polymer and/or an improved percentage of exfoliated or delaminated clay. Typical agents known in the art include general classes of materials such as organosilane, organozirconate and organotitanate coupling agents. However, the choice of the compatibilizing agent is very much dependent on the matrix polymer as well as the specific component used to intercalate the clay, since the compatibilizer has to act as a link between the two.

A survey of the art, makes it clear that there is a lack of general guideline for the selection of the intercalating and compatibilizing agents for a specific matrix polymer and clay combination. Even if one can identify these two necessary components through trial and error, they are usually incorporated as two separate entities, usually in the presence of water followed by drying, in a batch process and finally combined at a separate site with the matrix polymer during melt-processing of the nanocomposite. Such a complex process obviously adds to the cost of development and manufacturing of the final product comprising such a nanocomposite. There is a critical need in the art for a comprehensive strategy for the development of better materials and processes to overcome some of the aforementioned drawbacks.

Imaging elements such as photographic elements usually comprise a flexible thermoplastic base on which is coated the imaging material such as the photosensitive material. The thermoplastic base is usually made of polymers derived from the polyester family such as polyethylene terephthalate (PET), polyethylene naphthalate (PEN) and the base can also be a solvent coated based such as cellulose triacetate (TAC). Films for color, black and white photography, and motion picture print film are examples of imaging media comprising such flexible plastic bases in roll form. TAC has attributes of high transparency and curl resistance after processing but poor mechanical strength. PET on the other hand has excellent mechanical strength and manufacturability but undesirable post-process curl. The two former attributes make PET more amenable to film thinning, enabling the ability to have more frames for the same length of film. Thinning of the film however causes loss in mechanical strength. The stiffness will drop as approximately the cube root of the thickness of the film. Also a photosensitive material coated on the base in a hydrophilic gelatin vehicle will shrink and curl towards the emulsion when dry. Films may also be subjected to extrusion at high temperatures during use. Hence, a transparent film base that has dimensional stability at high temperatures due to its higher heat capacity is also highly desirable. For many coating applications, nanoparticles of polymers are used. However, the mechanical strength of these polymer materials is sometimes less than desired.

### PROBLEM TO BE SOLVED

There is a need to provide an imaging element with a flexible thermoplastic base having improved mechanical strength and other physical properties. There is a need for a base that is thinner yet stiff enough to resist this stress due to contraction forces. There is a need to use splayed clay to improve the mechanical strength, physical properties, and generate thinner base such that the splayant is an inorganic nanoparticle capable of withstanding high-temperature melt processing of the thermoplastic base.

### SUMMARY OF THE INVENTION

The present invention relates to a nanocomposite composition comprising a clay material splayed with an inorganic particle having a diameter equal to or less than 30 nanometers. Another embodiment of the invention includes a splayed material comprising a layered material splayed with a particle, wherein the particle comprises a diameter equal to or less than 30 nanometers. Another embodiment relates to a method for preparing an exfoliated nanocomposite composition comprising the steps of preparing an inorganic particle, mixing the particle with a layered material dispersed in a medium, and splaying the layered material to produce a nanocomposite, wherein the inorganic particle comprises a diameter equal to or less than 30 nanometers.

### ADVANTAGEOUS EFFECT OF THE INVENTION

The invention has numerous advantages, not all of which are incorporated into one single embodiment. Nanocomposites comprising a polymer matrix and a layered material intercalated, exfoliated or a combination of intercalated/exfoliated using nanoparticles may be aqueous, environmentally friendly systems and may be used without any further treatment in most applications. The nanocomposite may also be easily transformed into solids by drying, heating, or adding salt. Another advantage of using micro-particles or nanoparticles is the ease of manufacture, without melting, or the use of special instruments. The present invention consistently provides an exfoliated material.

The present invention advantageously may provide a universal method to manufacture nanocomposites of a polymer matrix and a layered material. Specifically, this invention may provide a method to manufacture nano-composite comprising a polymer matrix and an exfoliated layered material by mixing nanoparticles and the layered material in solution. This invention may also provide method of producing a nanocomposite comprising the layered material consistently exfoliated by nanoparticles in a polymer matrix or producing a splayed material, which may itself be effectively incorporated into a polymer-layered material nanocomposite. Such inorganic particle-layered material composition may be incorporated into an article of engineering application with improved physical properties such as modulus, tensile strength, toughness, impact resistance, electrical conductivity, heat distortion temperature, coefficient of linear thermal expansion, fire retardance, oxygen and water vapor barrier properties. The application of such articles in a number of industrial sectors, such as automotive, packaging, battery, cosmetics, aerospace, and the like have been elucidated in the literature, for example, “Polymer-Clay Nanocomposites,” Ed. T. J. Pinnavia and G. W. Beall, John Wiley & Sons, Ltd. Publishers.

Another advantage of some of the embodiments of the invention derives from the fact that the layered material, the particle and the matrix polymer may all be combined in a single step in a suitable solution, thus, adding greatly to the efficiency of the manufacturing process.

Additionally, the present invention teaches a general strategy wherein the chemistry of the particle may be tailored according to the choice of the layered material and the specific matrix polymer. The particle size may be controlled easily to meet the processing conditions, such as temperature, shear, viscosity and product needs, such as various physical properties.

### BRIEF DESCRIPTION OF THE DRAWINGS

FIG. 1 illustrates X-ray diffraction patterns of 10 nm SiO2/RDS clay nanocomposites at ratios of 1/1 or 4.5/1 respectively. SiO2/RDS clay 1/1 shows the clay has been splayed and SiO2/RDS clay 1/1 shows the clay has been exfoliated by 10 nm SiO2 nanoparticles of the present invention.

FIG. 2 illustrates X-ray diffraction patterns of a nanocomposite comprised of polyethylene oxide (PEO)/RDS clay at a ratio of 9/1, and of a nanocomposite comprised of PEO/10 nm SiO2/RDS clay at a ratio of 9/6/1. SiO2/clay at a ratio of 6/1 in a polymer matrix shows the clay has been exfoliated by 10 nm SiO2 nanoparticles of the present invention.

### DETAILED DESCRIPTION OF THE INVENTION

Whenever used in the specification the terms set forth shall have the following meaning:

“Nanocomposite” shall mean a composite material wherein at least one component comprises an inorganic phase, such as a smectite layered material, with at least one dimension in the 0.1 to 100 nanometer range. Another component may be a polymer.

“Plates” shall mean particles with two comparable dimensions significantly greater than the third dimension, e.g., length and width of the particle being of comparable size but orders of magnitude greater than the thickness of the particle.

“Layered material” shall mean an inorganic material such as a smectite layered material that is in the form of a plurality of adjacent bound layers.

“Platelets” shall mean individual layers of the layered material.

“Intercalation” shall mean the insertion of one or more foreign molecules or parts of foreign molecules between platelets of the layered material, usually detected by X-ray diffraction technique, as illustrated in U.S. Pat. No. 5,891,611 (line 10, col.5—line 23, col. 7). Intercalation is characterized by at least additional separation of the platelets, with some of the platelets separated but may also include an amount of unseparated platelets.

“Intercalant” shall mean the aforesaid foreign molecule inserted between platelets of the aforesaid layered material.

“Intercalated” shall refer to layered material that has at least partially undergone intercalation and/or exfoliation.

“Exfoliation” or “delamination” shall mean separation of individual platelets in to a fully disordered structure, without any significant stacking order. Exfoliation indicates that all or substantially all of the platelets are separated.

“Organo layered material” shall mean layered material modified by organic molecules.

“Splayed” layered materials are defined as layered materials which are completely intercalated with no degree of exfoliation, totally exfoliated materials with no degree of intercalation, as well as layered materials which are both intercalated and exfoliated including disordered layered materials.

“Splaying” refers to the separation of the layers of the layered material, which may be to a degree which still maintains a lattice-type arrangement, as in intercalation, or to a degree which spreads the lattice structure to the point of loss of lattice structure, as in exfoliation.

“Splayant” refers to the material, such as a polymeric particle or inorganic particle, used to splay the layered material.

The splayed (exfoliated or intercalated) or substantially exfoliated material made in the present invention comprises layered material splayed or preferably exfoliated with a particle. The particle, which may also be referred to as a splayant or splayant particle, is an inorganic nanoparticle with a diameter that is equal to or less than 30 nanometers. In preferred embodiments, the splayant material is an inorganic particle having a particle diameter of from 5 nanometers to 30 nanometers. For purposes of the present invention, a nanoparticle is a particle with a diameter of less than 0.5 micrometers. For purposes of the present invention, a microparticle is a polymeric particle with a diameter of between 0.5 and 3 micrometers. The splayant particle may be a nonporous or a porous particle. The particles may be in any form, shape or combination of forms and shapes, which include porous nanoparticles and core-shell particles. The resulting exfoliated layered material may form a nanocomposite, which may be used alone or as a master batch to mix with additional polymer matrix to form new nanocomposite materials.

The layered materials most suitable for this invention include materials in the shape of plates with significantly high aspect ratio. However, other shapes with high aspect ratio will also be advantageous. The layered materials suitable for this invention comprise clays or non-clays. These materials include phyllosilicates, e.g., montmorillonite, particularly sodium montmorillonite, magnesium montmorillonite, and/or calcium montmorillonite, nontronite, beidellite, volkonskoite, hectorite, saponite, sauconite, sobockite, stevensite, svinfordite, vermiculite, magadiite, kenyaite, talc, mica, kaolinite, and mixtures thereof. Other useful layered materials include illite, mixed layered illite/smectite minerals, such as ledikite and admixtures of illites with the layered materials named above. Other useful layered materials, particularly useful with anionic matrix polymers, are the layered double hydroxide clays or hydrotalcites, such as Mg₆Al_{3.4}(OH)_{18.8}(CO₃)_{1.7}H₂O, which have positively charged layers and exchangeable anions in the interlayer spaces. Other layered materials having little or no charge on the layers may be useful provided they may be splayed with swelling agents, which expand their interlayer spacing. Such materials include chlorides such as FeCl₃, FeOCl, chalcogenides, such as TiS₂, MoS₂, and MoS₃, cyanides such as Ni(CN)₂ and oxides such as H₂Si₂O₅, V₆O₁₃, HTiNbO₅, Cr_{0.5}V_{0.5}S₂, V₂O₅, Ag doped V₂O₅, W_{0.2}V_{2.8}O7, Cr₃O₈, MoO₃(OH)₂, VOPO₄-2H₂O, CaPO₄CH₃—H₂O, MnHAsO₄—H₂O, Ag₆ MolO₃₃ and the like. Preferred layered materials are swellable so that other agents, usually organic ions or molecules, may intercalate and/or exfoliate the layered material resulting in a desirable dispersion of the inorganic phase. These swellable layered materials include phyllosilicates of the 2:1 type, as defined in the literature (vide, for example, “An introduction to clay colloid chemistry,” by H. van Olphen, John Wiley & Sons Publishers). Typical phyllosilicates with ion exchange capacity of 50 to 300 milliequivalents per 100 grams are preferred. Preferred layered materials for the present invention include clays, especially smectite clay such as montmorillonite, nontronite, beidellite, volkonskoite, hectorite, saponite, sauconite, sobockite, stevensite, svinfordite, halloysite, magadiite, kenyaite and vermiculite as well as layered double hydroxides or hydrotalcites. Most preferred layered materials include montmorillonite, hectorite and hydrotalcites, because of commercial availability of these materials.

The aforementioned layered materials may be natural or synthetic, for example, synthetic smectite layered materials. This distinction may influence the particle size and/or the level of associated impurities. Typically, synthetic layered materials are smaller in lateral dimension, and therefore possess smaller aspect ratio. However, synthetic layered materials are purer and are of narrower size distribution, compared to natural clays and may not require any further purification or separation. For this invention, the clay particles should have a lateral dimension of between 0.01 μm and 5 μm, and preferably between 0.05 μm and 2 μm, and more preferably between 0.1 μm and 1 m. The thickness or the vertical dimension of the clay particles may vary between 0.5 nanometers and 10 nanometers, and preferably between 1 nanometers and 5 nanometers. The aspect ratio, which is the ratio of the largest and smallest dimension of the layered material particles should be >10:1 and preferably >100:1 and more preferably >1000:1 for this invention. The aforementioned limits regarding the size and shape of the particles are to ensure adequate improvements in some properties of the nanocomposites without deleteriously affecting others. For example, a large lateral dimension may result in an increase in the aspect ratio, a desirable criterion for improvement in mechanical and barrier properties. However, very large particles may cause optical defects, such as haze, and may be abrasive to processing, conveyance and finishing equipment as well as the imaging layers.

The clay used in this invention may be an organoclay. Organoclays are produced by interacting the unfunctionalized clay with suitable intercalants. Commercially available clays suitable for this invention include the Laponite®, Nanoclay®, Claytone®, and Permont® families of clays. For this invention Laponite®RDS is a preferred clay, a synthetic hectorite clay in the smectite family of clays. NaCloisite® is a preferred natural montmoillonite clay or Nanoclay, also in the smectite group.

Suitable inorganic nanoparticles, amorphous and/or in their different crystal modifications, which can be used in accordance with the invention include metals, metal compounds, such as metal oxides and metal salts, and also semimetal compounds and nonmetal compounds. Metal nanoparticles which can be used are noble metal nanoparticles, such as palladium, silver, ruthenium, platinum, gold and rhodium, for example, and their alloys. Particles may include titanates, stannates, tungstates, niobates or zirconates; in addition, silicates are also possible, depending on the type of basic particle selected. Examples that may be mentioned of metal oxides include titanium dioxide (TiO₂), zirconium(IV) oxide, tin(II) oxide, tin(IV) oxide, aluminum oxide, barium oxide, magnesium oxide, various iron oxides, such as iron(II) oxide (wustite), iron(III) oxide (hematite), iron(III) Oxide (maghemite) and iron(II/III) oxide (magnetite), chromium(III) oxide, antimony(III) oxide, bismuth(III) oxide, zinc oxide, nickel(II) oxide, nickel(III) oxide, cobalt(II) oxide, cobalt(III) oxide, copper(II) oxide, yttrium(III) oxide, cerium(IV) oxide, amorphous and/or in their different crystal modifications, and also their hydroxy oxides, such as, for example, hydroxytitanium(Iv) oxide, hydroxyzirconium(IV) oxide, hydroxyaluminum oxide) and hydroxyiron(III) oxide, amorphous and/or in their different crystal modifications. The following metal salts, amorphous and/or in their different crystal structures, can be used in the invention: sulfides, such as iron(II) sulfide, iron(III) sulfide, iron(II) disulfide (pyrite), tin(II) sulfide, tin(IV) sulfide, mercury(II) sulfide, cadmium(II) sulfide, zinc sulfide, copper(II) sulfide, silver sulfide, nickel(II) sulfide, cobalt(II) sulfide, cobalt(III) sulfide, manganese(II) sulfide, chromium(III) sulfide, titanium(II) sulfide, titanium(III) sulfide, titanium(IV) sulfide, zirconium(IV) sulfide, antimony(III) sulfide, and bismuth(III) sulfide, hydroxides, such as tin(II) hydroxide, aluminum hydroxide, magnesium hydroxide, calcium hydroxide, barium hydroxide, zinc hydroxide, iron(II) hydroxide, and iron(III) hydroxide, sulfates, such as calcium sulfate, strontium sulfate, barium sulfate, and lead(IV) sulfate, carbonates, such as lithium carbonate, magnesium carbonate, calcium carbonate, zinc carbonate, zirconium(IV) carbonate, iron(II) carbonate, and iron(III) carbonate, orthophosphates, such as lithium orthophosphate, calcium orthophosphate, zinc orthophosphate, magnesium orthophosphate, aluminum orthophosphate, tin(III) orthophosphate, iron(II) orthophosphate, and iron(III) orthophosphate, metaphosphates, such as lithium metaphosphate, calcium metaphosphate, and aluminum metaphosphate, pyrophosphates, such as magnesium pyrophosphate, calcium pyrophosphate, zinc pyrophosphate, iron(III) pyrophosphate, and tin(II) pyrophosphate, ammonium phosphates, such as magnesium ammonium phosphate, zinc ammonium phosphate, hydroxyapatite [Ca (5)[(PO (4)) (3)OH]], orthosilicates, such as lithium orthosilicate, calcium/magnesium orthosilicate, aluminum orthosilicate, iron orthosilicates, magnesium orthosilicate, zinc orthosilicate, and zirconium orthosilicates, metasilicates, such as lithium metasilicate, calcium/magnesium metasilicate, calcium metasilicate, magnesium metasilicate, and zinc metasilicate, sheet silicates, such as sodium aluminum silicate and sodium magnesium silicateSaponit® SKS-20 and Hektorits® SKS 21 (trademarks of Hoechst AG), and Laponite® RD and Laponite® GS (trademarks of Laporte Industries Ltd.), aluminates, such as lithium aluminate, calcium aluminate, and zinc aluminate, borates, such as magnesium metaborate and magnesium orthoborate, oxalates, such as calcium oxalate, zirconium(IV) oxalate, magnesium oxalate, zinc oxalate, and aluminum oxalate, tartrates, such as calcium tartrate, acetylacetonates, such as aluminum acetylacetonate and iron(III) acetylacetonate, salicylates, such as aluminum salicylate, citrates, such as calcium citrate, iron(II) citrate, and zinc citrate, palmitates, such as aluminum palmitate, calcium palmitate, and magnesium palmitate, stearates, such as aluminum stearate, calcium stearate, magnesium stearate, and zinc stearate, laurates, such as calcium laurate, linoleates, such as calcium linoleate, and oleates, such as calcium oleate, iron(II) oleate, and zinc oleate. Other suitable inorganic particles may include Fe 2O3, PbO, Pb3O4 or Bi2O3, Fe3O4, La2O3, Sm2O3, Tb4O7, Eu2O3, and mixtures thereof including doped inorganic particles such as Sb-doped SnO2. In addition to the materials listed above, other alkaline earth metal salts such as magnesium sulfate, silver halides (e.g., silver chloride, silver bromide), glass, and the like, may be used as nanoparticles. The preferred nanoparticles are SiO2, including amorphous SiO2, quartz SiO2 or cristobalite SiO2 phases, ZnSb2O4, Sb2O3, SnO2, Al2O3, ZrO2 and ZnO.

The ratio of inorganic nanoparticle may be varied, as appropriate, to produce the desired level of intercalation or total exfoliation. The preferred level to achieve intercalation is approximately 1 part inorganic nanoparticle to 1 part clay. To achieve total exfoliation, a ratio of at least 3 parts inorganic nanoparticle to 1 part clay is desired. The most preferred ratio to achieve total exfoliation is at least 6 parts inorganic nanoparticle to 1 part clay. The ratio to achieve total exfoliation is believed to be affected by morphology (shape) of the particles, with needle-like or plate-like morphologies performing generally better than round morphologies, and chemical interaction or compatibility, for example where silica performs generally better when combined with a silicate.

The splayed material, preferably a nanocomposite, may be made by any method used to prepare a nanoparticle in water or organic solvent. In one suitable embodiment, the method for preparing a nanocomposite comprises the steps of preparing or providing an inorganic particle with a diameter equal to or less than 30 nanometers, for example, Sb2O3 particles with a diameter of 20 nm, mixing the particle with a layered material dispersed in a medium, and splaying the layered material to produce a nanocomposite. The medium preferred for dispersing the particles and layered materials used to make the nanocomposites of the present invention may comprise an aqueous medium, an organic solvent, or a polymer, or mixtures thereof.

The splayed material of the present invention may find many uses alone, such as a coating element, an imaging element, a viscosity modifier, and the like. The splayed material of the present invention may also be combined with a matrix polymer to form an article. In a preferred embodiment, the article comprises a matrix binder or polymer and a layered material splayed with a polymeric particle dispersed in a medium.

The layered materials and the nanoparticles of the invention may be interacted for intercalation/exfoliation by any suitable means known in the art of making nanocomposites. The order and the method of addition of layered material, microparticles or nanoparticles, and optional addenda may be varied.

The material of the instant invention comprising the layered materials and the nanoparticles or the article, together with any optional addenda, may be formed by any suitable method such as, extrusion, co-extrusion with or without orientation by uniaxial or biaxial, simultaneous or consecutive stretching, blow molding, injection molding, lamination, solvent casting, and the like.

Suitable matrix polymers for use in the invention may be any natural or synthetic polymer. The matrix polymer may also be any water soluble, water insoluble but dispersible, or water insoluble polymer. The water soluble polymers preferred include gelatin, poly(vinyl alcohol), poly(ethylene oxide), polyvinylpyrolidinone, poly(acrylic acid), poly(styrene sulfonic acid), polyacrylamide, and quaternized polymers. Other suitable matrix polymers may include aqueous emulsions of addition-type homopolymers and copolymers prepared from ethylenically unsaturated monomers such as acrylates including acrylic acid, methacrylates including methacrylic acid, acrylamides and methacrylamides, itaconic acid and its half-esters and diesters, styrenes including substituted styrenes, acrylonitrile and methacrylonitrile, vinyl acetates, vinyl ethers, vinyl and vinylidene halides, and olefins and aqueous dispersions of polyurethanes and polyesterionomers.

Other water insoluble matrix polymers include polyester, polyethersulfone, polycarbonate, polysulfone, a phenolic resin, an epoxy resin, polyimide, polyetherester, polyetheramide, cellulose nitrate, cellulose acetate such as cellulose diacetate or cellulose triacetate, poly(vinyl acetate), polystyrene, polyolefins including polyolefin ionomers, polyamide, aliphatic polyurethanes, polyacrylonitrile, polytetrafluoroethylenes, polyvinylidene chlorides and fluorides, poly(methyl x-methacrylates), an aliphatic or cyclic polyolefin, polyarylate, polyetherimide, polyethersulphone, polyimide, Teflon poly(perfluoro-alboxy) fluoropolymer, poly(ether ether ketone), poly(ether ketone), poly(ethylene tetrafluoroethylene)fluoropolymer, poly(methyl methacrylate), various acrylate or methacrylate copolymers, natural or synthetic paper, resin-coated or laminated paper, voided polymers including polymeric foam, microvoided polymers, microporous materials, fabric, or any blend or interpolymer thereof.

The matrix polymer may also contain optional addenda, which may include, but are not limited to, nucleating agents, fillers, plasticizers, impact modifiers, chain extenders, colorants, lubricants, antistatic agents, pigments such as titanium oxide, zinc oxide, talc, calcium carbonate, dispersants such as fatty amides, (for example, stearamide), metallic salts of fatty acids, for example, zinc stearate, magnesium stearate, dyes such as ultramarine blue, cobalt violet, antioxidants, fluorescent whiteners, ultraviolet absorbers, fire retardants, roughening agents, cross linking agents, surfactants, lubricants and voiding agents. These optional addenda and their corresponding amounts can be chosen according to need.

The layered materials and the nanoparticles of the invention may be further interacted with matrix polymers by any suitable means known in the art of making nanocomposites. The order and method of addition of layered material, nanoparticles, matrix, and optional addenda may be varied.

In one embodiment, the layered materials may be initially mixed with a suitable nanoparticles followed by mixing with a matrix. In another embodiment, the layered materials may simultaneously be mixed with a suitable nanoparticles and a matrix. In another embodiment, the layered materials and nanoparticles may be dispersed in suitable matrix monomers or oligomers. In another embodiment, the layered materials may be melt blended with the nanoparticles, followed by mixing with a matrix at temperatures preferably comparable to the matrix melting point or above, with or without shear. In another embodiment, the layered materials may be melt blended with the nanoparticles and matrix at temperatures preferably comparable to the matrix melting point or above, with or without shear. Another method for preparing a nanocomposite involves emulsifying or milling a solvent borne polymer with a surfactant in a medium in which the polymer is not dispersible and removing the solvent to form an inorganic particle, mixing the inorganic particle with a clay material dispersible in the medium, and splaying the clay material to produce a nanocomposite.

In another embodiment, the layered materials and the nanoparticles may be combined in a solvent phase to achieve intercalation/exfoliation followed by mixing with a matrix. The resultant solution or dispersion may be used as is or with solvent removal through drying. The solvent may be aqueous or organic. The organic solvent may be polar or nonpolar. In yet another embodiment, the layered materials, the nanoparticles, and the matrix may be combined in a solvent phase to achieve intercalation/exfoliation. The resultant solution or dispersion may be used as is or with solvent removal through drying. The solvent may be aqueous or organic. The organic solvent may be polar or nonpolar.

For the practice of the present invention, it is important to ensure compatibility between the matrix polymer and at least part of the nanoparticles. For the purposes of the present invention, compatibility refers to miscibility at the molecular level. If the matrix polymer comprises a blend of polymers, the polymers in the blend should be compatible with at least part of the nanoparticles. If the matrix polymer comprises copolymer(s), the copolymer(s) should be compatible with at least part of the nanoparticles.

In one suitable embodiment of the invention the layered material, together with any optional addenda, is melt blended with the nanoparticles of the invention in a suitable twin screw compounder, to ensure proper mixing. An example of a twin screw compounder used for the experiments detailed below is a Leistritz Micro® 27. Twin screw extruders are built on a building block principle. Thus, the mixing of additives, the residence time of resin, as well as the point of addition of additives may be easily changed by changing the screw design, the barrel design and the processing parameters. Other compounding machines for use in preparing the present invention include, but are not limited to twin screw compounders manufactured by Werner and Pfleiderrer, and Berstorff. These compounders may be operated either in the co-rotating or the counter-rotating mode.

The screws of the Leistritz compounder are 27 mm in diameter, and they have a functionary length of 40 diameters. The maximum number of barrel zones for this compounder is 10. The maximum screw rotation speed for this compounder is 500 rpm. This twin screw compounder is provided with main feeders through which resins are fed, while additives might be fed using one of the main feeders or using the two side stuffers. If the side stuffers are used to feed the additives, the screw design needs to be appropriately configured.

The preferred mode of addition of layered materials to the nanoparticles is through the use of the side stuffer to ensure the splaying of the layered materials through proper viscous mixing and to ensure dispersion of the filler through the polymer matrix as well as to control the thermal history of the additives. In this mode, the nanoparticles are fed using the main resin feeder, and is followed by the addition of layered materials through the downstream side stuffer or vice versa. Alternatively, the layered materials and nanoparticles may be fed using the main feeders at the same location or the layered materials and nanoparticles are premixed and fed through a single side stuffer. This method is particularly suitable if there is only one side stuffer port available, and if there are limitations on the screw design.

In addition to the compounders described above, the article of the present invention may be produced using any suitable mixing device such as a single screw compounder, blender, mixer, spatula, press, extruder, or molder.

The article of the invention may be of any size and form, a liquid such as a solution, dispersion, latex and the like, or a solid such as a sheet, rod, particulate, powder, fiber, wire, tube, woven, non-woven, support, layer in a multilayer structure, and the like. The article of the invention may be used for any purpose, as illustrated by packaging, woven or non-woven products, protective sheets or clothing, and medical implement.

In one preferred embodiment of the invention, the article of the invention comprises the base of an imaging member. Such imaging members include those utilizing photographic, electrophotographic, electrostatographic, photothermographic, migration, electrothermographic, dielectric recording, thermal dye transfer, inkjet and other types of imaging. In a more preferred embodiment of the invention, the article of the invention comprises the base of a photographic imaging member, particularly a photographic reflective print material, such as paper or other display product. In another preferred embodiment, the article may comprise a coating element.

Typical bases for imaging members comprise cellulose nitrate, cellulose acetate, poly(vinyl acetate), polystyrene, polyolefins, poly(ethylene terephthalate), poly(ethylene naphthalate), polycarbonate, polyamide, polyimide, glass, natural and synthetic paper, resin-coated paper, voided polymers, microvoided polymers, microporous materials, nanovoided polymers and nanoporous materials, fabric, and the like.

The material of the invention comprising a matrix polymer and the splayed layered materials may be incorporated in any of these materials and/or their combination for use in the base of the appropriate imaging member. In case of a multilayered imaging member, the aforementioned material of the invention may be incorporated in any one or more layers, and may be placed anywhere in the imaging support, e.g., on the topside, or the bottom side, or both sides, and/or in between the two sides of the support. The method of incorporation may include extrusion, co-extrusion with or without stretching, blow molding, casting, co-casting, lamination, calendering, embossing, coating, spraying, molding, and the like. The image receiving layer or layers, as per the invention, may be placed on either side or both sides of the imaging support.

In one preferred embodiment, the imaging support of the invention comprising a matrix polymer and the splayed layered materials of the invention may be formed by extrusion and/or co-extrusion, followed by orientation, as in typical polyester based photographic film base formation. Alternatively, a composition comprising a matrix polymer and the splayed layered materials of the invention may be extrusion coated onto another support, as in typical resin coating operation for photographic paper. In another embodiment, a composition comprising a matrix polymer and the splayed layered materials of the invention may be extruded or co-extruded and preferably oriented into a preformed sheet and subsequently laminated to another support, as in the formation of typical laminated reflective print media.

In another embodiment, the material of this invention may be incorporated in imaging supports used for image display such as reflective print media including papers, particularly resin-coated papers, voided polymers, and combinations thereof. Alternatively, the imaging support may comprise a combination of a reflective medium and a transparent medium, in order to realize special effects, such as day and night display. In a preferred embodiment, at least one layer comprising the material of the present invention is incorporated in a paper support, because of its widespread use. In another preferred embodiment, at least one layer comprising the nanocomposite of the present invention may be incorporated into an imaging support comprising a voided polymer, because of its many desirable properties such as tear resistance, smoothness, improved reflectivity, metallic sheen, and day and night display usage.

The imaging supports of the invention may comprise any number of auxiliary layers. Such auxiliary layers may include antistatic layers, back mark retention layers, tie layers or adhesion promoting layers, abrasion resistant layers, conveyance layers, barrier layers, splice providing layers, UV absorption layers, antihalation layers, optical effect providing layers, waterproofing layers, and the like.

The article of the present invention may be used in non-imaging applications as well. For example, the article may comprise a viscosity modifier, adhesives, engineering resins, lubricants, polymer blend component, biomaterial, water treatment additives, cosmetics component, antistatic agent, food and beverage packaging material, semi-conductor, super conductor, or releasing compound agent in pharmaceuticals applications.

### EXAMPLES

The following examples illustrate the practice of this invention. They are not intended to be exhaustive of all possible variations of the invention. Parts and percentages are by weight unless otherwise indicated.

Laponite® RDS is a synthetic hectorite clay in the smectite family of clays. Additionally, Laponite® RDS is a water dispersable clay. Table 1 identifies layered material L1 and associated basal plane interplanar spacing. The layered material used was:

TABLE 1

| | | | (001) Clay Basal |
|---|---|---|---|
| | | | Plane Interplanar |
| Layered | | | Spacing (Å) XRD |
| Material ID | Name | Supplier | results |
| L1 | Laponite ® RDS | Southern Clay | 13.6 |
| | | Products | |

All Examples and Comparative Examples presented here were generated using Laponite® RDS as the layered inorganic. The RDS clay (001) basal plane spacing was determined by X-ray diffraction using a Rigaku Bragg-Brentano diffractometer in reflection mode geometry utilizing a monochromator tuned to CuKα radiation. All measurements were performed in ambient air.

The clay was first dispersed in water and agitated with a magnetic stirrer. The nanoparticle dispersion was added into the solution with further agitation. The solution was coated onto a solid glass support, followed by drying under ambient conditions.

Table 2 identifies nanoparticles P1-P4 and associated specific particle size. The nanoparticles used were:

TABLE 2

| | | | | | (001) Clay |
|---|---|---|---|---|---|
| | | | | | Basal Plane |
| | | | Particle | | Interplanar |
| | | Particle Type | size | | Spacing (Å) |
| Nanocomposite | ID | (NP) | (nm) | NP/RDS | XRD results |
| EC1 | P1 | Sb₂O₃ | 20 | 1.5/1 | 15.1 |
| EC2 | P1 | Sb₂O₃ | 20 | 3/1 | 15.8 + Exf. |
| EC3 | P1 | Sb₂O₃ | 20 | 6/1 | Exf. |
| EC4 | P2 | ZnSb₂O₄ | 30 | 6/1 | Exf. |
| EC5 | P3 | SnO₂ | 20 | 6/1 | Exf. |
| EC6 | P4 | MA-ST-UP | 5-10 | 1/1 | 20.3 + Exf. |
| | | elongated SiO₂ | | | |
| EC7 | P4 | MA-ST-UP | 5-10 | 3/1 | Exf. |
| | | elongated SiO₂ | | | |
| EC8 | P4 | MA-ST-UP | 5-10 | 4.5/1 | Exf. |
| | | elongated SiO₂ | | | |
| EC9 | P4 | MA-ST-UP | 5-10 | 6/1 | Exf. |
| | | elongated SiO₂ | | | |

Exf—exfoliated

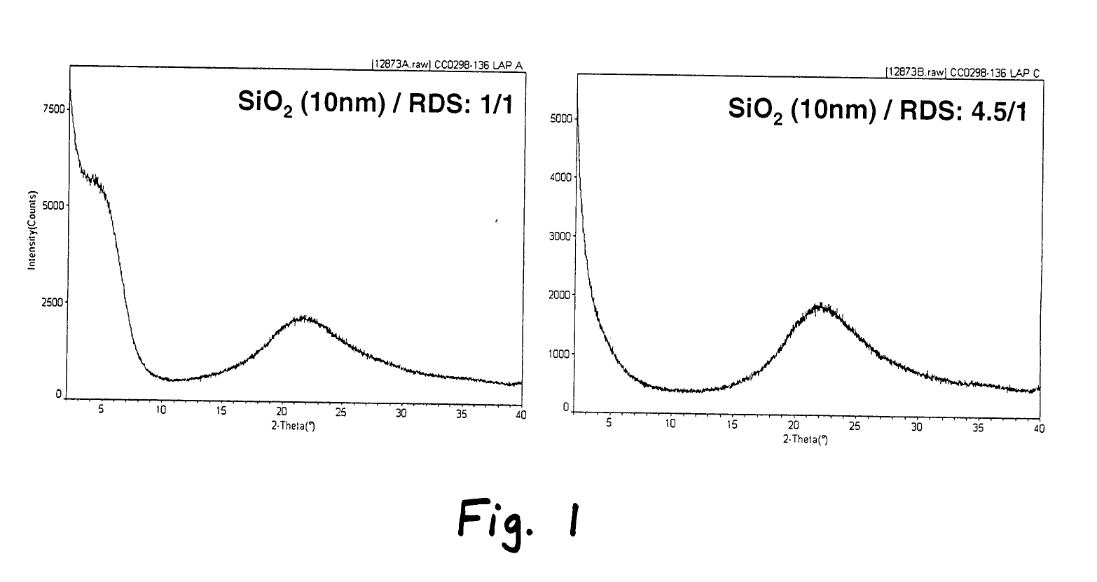

The results in Table 2 indicate that, when a nanocomposite was formed, having a ratio of Sb2O3 nanoparticulate to clay of 1.5/1, the resulting clay nanocomposite was intercalated, however it was not exfoliated. A second example illustrated that, when utilizing the same nanoparticle at a ratio of Sb₂O₃ to Laponite®) RDS of 3/1, the layered material was splayed and exfoliated, but not fully exfoliated. Example EC3, having a ratio of inorganic nanoparticle to clay of 6/1, yielded a fully exfoliated nanocomposite. Additional nanocomposites EC4 and EC5, utilizing ZnSb₂O₄ having a particle size of 30 nanometers, and SnO₂, having a specific particle size of 20 nanometers, both yielded fully exfoliated nanocomposite. Examples EC6, EC7, EC8 and EC9 utilizing MA-ST-UP or elongated SiO₂, having a specific particle size of 5-10 nm, at the ratio of inorganic nanoparticle to clay of 1/1 was splayed (intercalated and exfoliated), and at ratios of 3/1, 4.5/1 and 6/1, yielded fully exfoliated nanocomposite, respectively. X-ray diffraction patterns for SiO2/RDS at ratios of 1/1 and 4.5/1 are shown in FIG. 1. The broad diffraction peak at 4.4 degrees 2-theta for 1/1 is an indication that the clay is splayed, that is, a combination of intercalated and exfoliated clay. The absence of a diffraction peak at low 2-theta angle for 4.5/1 is an indication that the clay is exfoliated.

Comparative examples are in Table 3. Clay was dispersed in water, inorganic particles with particle size greater than 1 micron, i.e. greater than 1000 nm were added, then a few drops of each mixture were dispersed on a glass substrate, dried in ambient air, then analyzed by XRD. The XRD results demonstrate that large inorganic particles do intercalate or exfoliate the clay. The neat RDS spacing is 13.6 angstroms.

TABLE 3

| | | | | | (001) Clay |
|---|---|---|---|---|---|
| | | | | | Basal Plane |
| | | | Particle | | Interplanar |
| | | | size | Particle/ | Spacing (Å) |
| Nanocomposite | ID | Particle Type | (nm) | RDS | XRD results |
| Comp Ex 1 | CP1 | SiO2, | >1000 | 3/1 | 13.6 |
| | | cristobalite | | | |
| Comp Ex 2 | CP2 | SiO2, quartz | >1000 | 3/1 | 13.6 |
| Comp Ex 3 | CP3 | Sb2O3 | >1000 | 6/1 | 13.6 |

Table 3 illustrates that particle sizes larger than those of the present invention do not splay, intercalate or exfoliate.

Table 4 shows results for Comparative example 4 and Example 10. In Comparative Example 4, PEO and clay were dispersed in water, with no inorganic particle added, then a few drops of were dispersed on a glass substrate, dried in ambient air, then analyzed by XRD. In Example 10, PEO and clay were dispersed in water, then inorganic SiO2 particles were added, then a few drops were dispersed on a glass substrate, dried in ambient air, then analyzed by XRD.

TABLE 4

| | | | | | | Clay |
|---|---|---|---|---|---|---|
| | | | | | | Basal |
| | | | | | | Plane |
| | | | | | | Interplanar |
| | | | | Particle | | Spacing |
| | | Particle | | size | Particle/ | (Å) XRD |
| Nanocomposite | ID | Type | Polymer | (nm) | RDS | results |
| Comp Ex 4 | | none | PEO | | | 17.9 |
| EC10 | P4 | MA-ST- | PEO | 5-10 | 6/1 | Exf. |
| | | UP | | | | |
| | | elongated | | | | |
| | | SiO₂ | | | | |

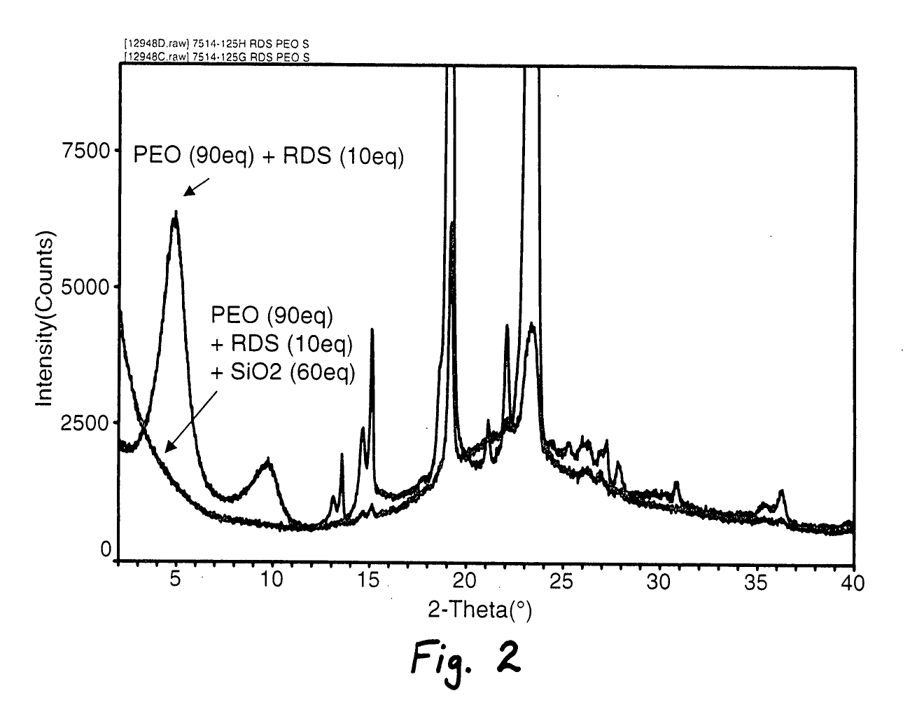

The data in Table 4 and X-ray diffraction patterns in FIG. 2 illustrate that Comparative Example 4 clay in the presence of PEO polymer shows only an intercalated clay that is not exfoliated. Example 10 clay mixed with 5-10 nm SiO2 in the presence of polymer shows clay is exfoliated.

The invention has been described in detail with particular reference to certain preferred embodiments thereof, but it will be understood that variations and modifications may be effected within the spirit and scope of the invention.

1. A nanocomposite composition comprising a clay material splayed with an inorganic particle wherein said inorganic particle has a diameter equal to or less than 30 nanometers.

2. The nanocomposite composition of claim 1 wherein said clay material splayed with an inorganic particle is clay material exfoliated with an inorganic particle.

3. The nanocomposite composition of claim 1 wherein the aspect ratio of the clay is greater than 10 to 1.

4. The nanocomposite composition of claim 1 wherein the inorganic particle is between 5 nanometers and 30 nanometers.

5. The nanocomposite composition of claim 1 further comprising a matrix polymer.

6. The nanocomposite composition of claim 5 wherein the matrix polymer is dispersible in water.

7. The nanocomposite composition of claim 1 wherein the ratio of inorganic nanoparticle to clay is six parts inorganic nanoparticle to one part clay.

8. The nanocomposite composition of claim 1 wherein the clay is a smectite clay.

9. The nanocomposite composition of claim 1 wherein the inorganic particle is Sb₂O₃ having a diameter of 20 nanometers.

10. The nanocomposite composition of claim 1 wherein said inorganic particle is ZnSb₂O₄, SnO₂, Sb₂O₃, amorphous SiO2, or SiO₂ (cristobalite), SiO2 (quartz)

11. A splayed material comprising a layered material splayed with a particle, wherein said particle comprises a diameter equal to or less than 30 nanometers.

12. The nanocomposite composition of claim 11 wherein said clay material splayed with an inorganic particle is clay material exfoliated with an inorganic particle.

13. The material of claim 11 wherein said particle comprises a nanoparticle 5 nanometers and 30 nanometers in diameter.

14. The material of claim 11 wherein said particle is prepared by milling a polymer and a dispersant in a medium, wherein said polymer is not soluble in said medium.

15. The material of claim 14 wherein said medium comprises an aqueous medium.

16. The material of claim 14 wherein said medium comprises an organic solvent.

17. The material of claim 11 wherein said layered material is a clay.

18. The material of claim 17 wherein said clay comprises smectite clay.

19. The material of claim 17 wherein said clay comprises layered double hydroxide clay.

20. The material of claim 11 wherein said material comprises a coating element.

21. The material of claim 11 wherein said material comprises an imaging element.

22. The material of claim 11 wherein said material comprises a viscosity modifier.

23. A method for preparing an exfoliated nanocomposite composition comprising the steps of preparing an inorganic particle, mixing said particle with a layered material dispersed in a medium, and splaying said layered material to produce a nanocomposite, wherein said inorganic particle comprises a diameter equal to or less than 30 nanometers.

24. The nanocomposite composition of claim 23 wherein said splaying is exfoliating.
